(19) United States
(12) Patent Application Publication
(10) Pub. No.: US 2012/0109774 A1
(43) Pub. Date: May 3, 2012

(54) INTEGRATED CLOUD BASED MARKETPLACE SERVICES

(75) Inventors: Vyacheslav Chernenko, Copenhagen (DK); Volodymyr Giginiak, Copenhagen (DK); Dmytro Sitnik, Copenhagen (DK); Ivan Kashperuk, Copenhagen (DK); Slavik Dimitrovich, Seattle, WA (US); Dmytro Kryshtalov, Copenhagen (DK)

(73) Assignee: Microsoft Corporation, Redmond, WA (US)

(21) Appl. No.: 12/938,729

(22) Filed: Nov. 3, 2010

Related U.S. Application Data
(63) Continuation of application No. 12/938,613, filed on Nov. 3, 2010.

(51) Int. Cl. G06Q 30/00

(52) U.S. Cl. 705/26.4

(57) ABSTRACT

Cloud based services are provided enabling electronic data interchange between suppliers and consumers of goods and services with the integration of business tools for finance, manufacturing, customer relationship management, supply chains, analytics and electronic commerce. By providing a compatibility layer to these business tools between various suppliers and consumers of goods and services, workflows can be extended with cloud-based services and automatic supply-demand matching provided based on constraints specified by the suppliers and consumers. Real-time (event-driven) order fulfillment can be implemented through the cloud based services.

### RELATED APPLICATIONS

This application is a continuation of co-pending U.S. patent application Ser. No. 12/938,613 filed on Nov. 3, 2010 by the same inventors, commonly assigned herewith.

### BACKGROUND

Business-to-business (B2B) marketplace refers to an online platform where buyers and sellers come into contact with each other and undertake business transactions such as buying, selling, supplying and wholesaling with the help of electronic commerce arena. Manufacturers, wholesalers, and suppliers promote their business on the web and attract potential customers. A B2B portal typically encourages and eases the communication channel between buyers and sellers resulting in dynamic international trade. B2B may act as a virtual office for any company where leads and offers are generated by way of sending or receiving business inquiry. These online portals help to organize a trusted business platform filled with features and benefits that allows its members to undertake different business processes over the web and enhance business productivity.

The buyers and sellers (or suppliers and consumers) in a B2B marketplace typically employ varying business tools that create, monitor, and otherwise process requests (e.g., RFQs), orders, quotations, and comparable business operations. When differing tools are used, matching supply and demand, and performing subsequent interactions can be burdensome, where a consumer may have to customize their interactive business tools for each vendor or vice versa. Furthermore, the potential incompatibility between different systems may result in inefficiencies in matching supply and demand as well. For example, a vendor may have to manually search active requests to determine which are compatible with their offerings or a consumer may have to search vendor offerings to find matching services and goods that satisfy their needs resulting in missed opportunities. While there are many business tools that integrate operational aspects such as manufacturing, inventory, planning, and purchasing operations, when these tools do not optimally interact between suppliers and consumers, the B2B marketplace cannot function efficiently.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to cloud based services for enabling electronic data interchange with the integration of business tools for finance, manufacturing, customer relationship management, supply chains, analytics and electronic commerce. By providing a compatibility layer to these business tools between various suppliers and consumers of goods and services, workflows may be extended with cloud-based services and automatic supply-demand matching provided based on constraints specified by the suppliers and consumers. According to some embodiments, real-time (event-driven) order fulfillment may be implemented through the cloud based services.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example environment of cloud based services bringing together suppliers and consumers;

FIG. 2 illustrates example services that may be provided by a cloud based service platform according to some embodiments;

FIG. 3 illustrates an architecture of a cloud based service platform;

FIG. 4 illustrates potential actions that may be performed in a cloud based service environment by owners, suppliers, and consumers;

FIG. 5 illustrates an example architecture for sourcing within a cloud based service platform according to embodiments;

FIG. 6 illustrates another example architecture for selling within a cloud based service platform according to embodiments;

FIG. 7 illustrates a further example architecture for supply and demand matching within a cloud based service platform according to embodiments;

FIG. 8 is a networked environment, where a system according to embodiments may be implemented;

FIG. 9 is a block diagram of an example computing operating environment, where embodiments may be implemented; and

FIG. 10 illustrates a logic flow diagram for a process of providing cloud based services in a B2B environment according to embodiments.

### DETAILED DESCRIPTION

As briefly described above, cloud based services for enabling electronic data interchange may be provided with integrated business tools for finance, manufacturing, customer relationship management, supply chains, analytics and electronic commerce. By providing a compatibility layer to these business tools between various suppliers and consumers of goods and services, workflows may be extended with cloud-based services and automatic supply-demand matching provided based on constraints specified by the suppliers and consumers. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a server, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for providing cloud based business-to-business services. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

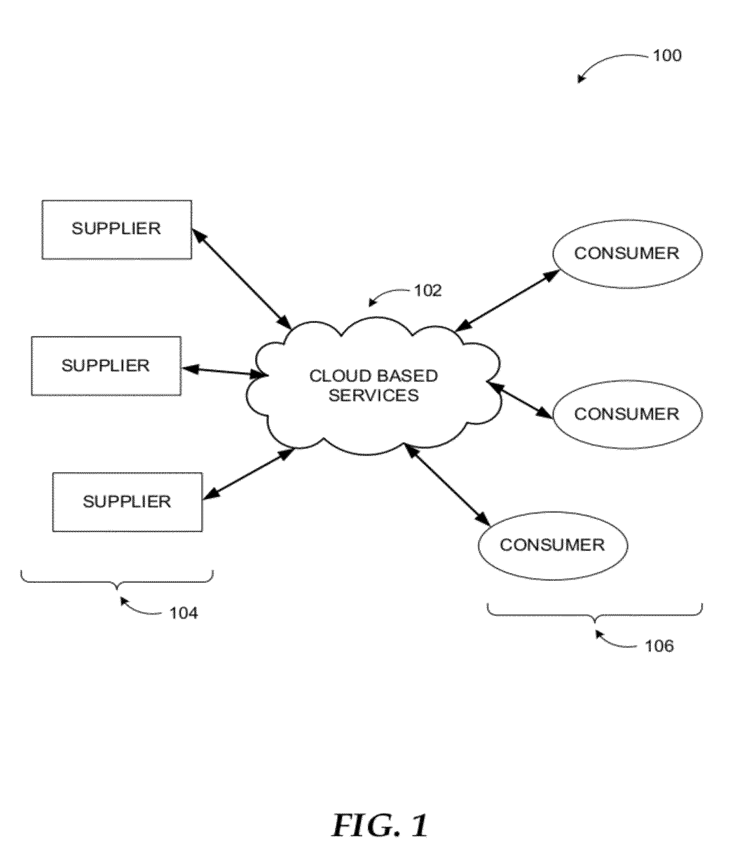

FIG. 1 illustrates an example environment of cloud based services bringing together suppliers and consumers. As shown in diagram 100, cloud based business-to-business services may be provided through one or more applications executed on a plurality of servers to supplier and consumer client devices (or servers) via one or more networks 102. The cloud based services may interface with their users through a B2B online portal, which enables suppliers 104 and consumers 106 of goods and services to interact with their counterparts and exchange information associated with business transactions. The entities participating in the cloud based services may include manufacturers, exporters, importers, suppliers, wholesalers, and comparable organizations. The online portals help to organize a trusted business platform filled with features and benefits that allow its members to undertake different business processes over the web and enhance business productivity.

While large businesses may dictate to their vendors (or in some cases, consumers of their services) the systems and interfaces to be used for interacting with their business tools for offering, ordering, management of deliveries, payments, etc., most small and medium size businesses are not in that position. A majority of businesses employ automation tools such as enterprise resource planning (ERP) systems, which can interact with other businesses and optimize the efficiency of business transactions. However, organizations using different types of tools and modules may not be able to interact easily. Components of their systems may need to be modified, new modules developed, maintained, and so on.

According to some embodiments, a cloud based service may be implemented as a middleware and enable electronic data interchange with the integration of business tools for finance, manufacturing, customer relationship management, supply chains, analytics and electronic commerce. The cloud based service may not only provide a compatibility layer to these business tools, but also automate some of tasks such as extending workflows, supply-demand matching based on constraints specified by the suppliers and consumers, and similar operations.

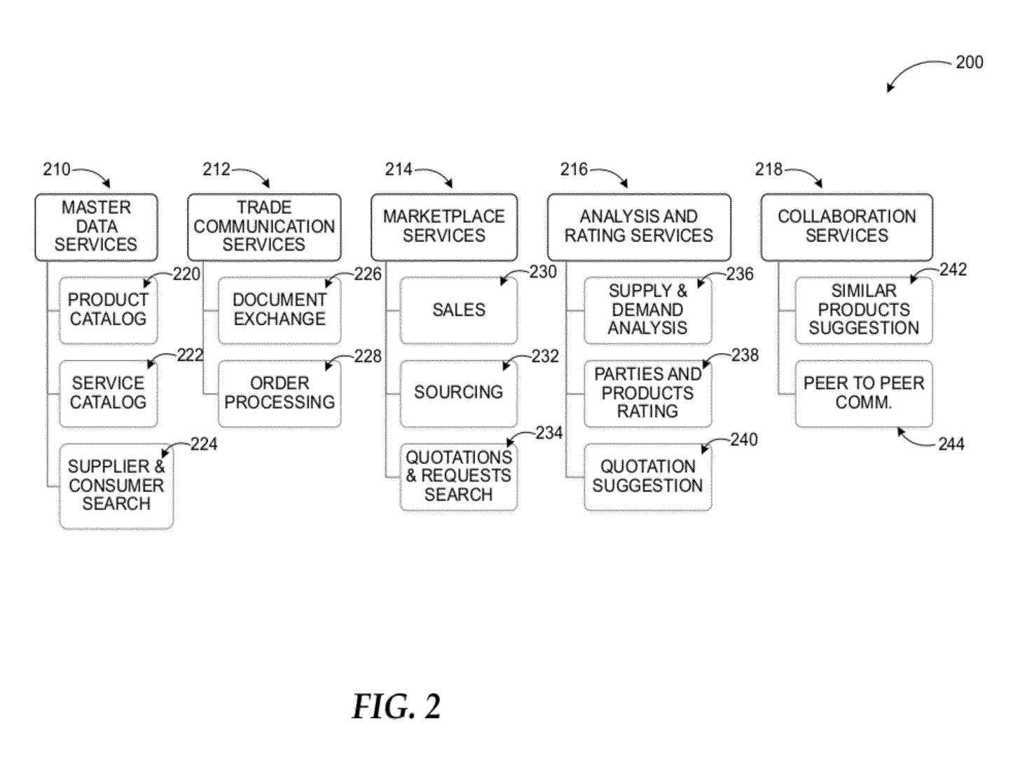

FIG. 2 illustrates example services that may be provided by a cloud based service platform according to some embodiments. A cloud based service platform according to some embodiments may provide an electronic data interchange interface for exchanging business data between different business tools of suppliers and consumers. The services may be available on demand and not require any infrastructure investments like deployment, maintenance, etc. Client integration artifacts may also be provided to enable seamless integration of the cloud based services with the standard functionality of business tool components.

The platform may include cloud based services, which are aligned with standard business processes employed by the business tools such as procure to pay, order to cash, master data management, and similar ones. The platform may also define data contracts aligned with standard electronic data interchange artifacts. Moreover, the platform may also enable the extension of standard application workflows provided by various business tools.

Diagram 200 illustrates some example specific services and their main categories. For example, under master data services 210 category, the platform may provide product catalogs 220, service catalogs 222, supplier & consumer searches 224, and comparable ones. Under the category trade communication services 212, services like document exchange 226 and order processing 228 may be provided. Under the category marketplace services 214, services like sales 230, sourcing 232, and quotation & request search 234 may be provided. Under the category analysis and rating services 216, services such as supply and demand analysis 236, parties and products rating 238, and quotation suggestion 240 may be provided. Under collaboration services 218 category, similar product suggestion 242, peer-to-peer communication 244, and similar services may be provided.

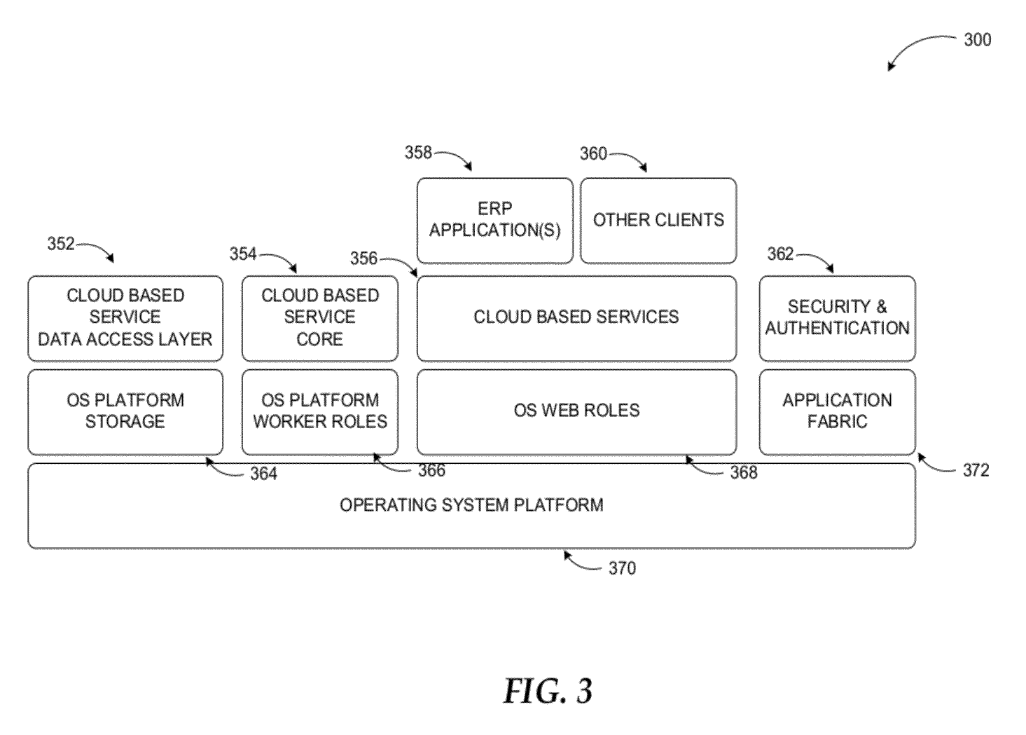

FIG. 3 illustrates an architecture of a cloud based service platform. As shown in diagram 300, the foundation for the cloud based services platform is a web based operating system platform 370 that is configured to provide a wide range of Internet services that can be consumed from both on-premises environments or the Internet.

Operating system platform 370 may be an application platform in the cloud that allows applications to be hosted and run at service provider datacenters. The operating system may serve as a runtime for the applications and provide a set of services that allows development, management, and hosting of applications off-premises. The operating system platform 370 may have three core components: computation, storage (OS platform storage 364), and fabric (application fabric 372). As the name suggests, computation component may provide a computation environment with web roles 368 and worker roles 366. OS platform storage 364 may provide scalable storage (e.g., blobs, tables, queues, drives, etc.) for scalable needs.

Application fabric 372 makes up the physical underpinnings of the operating system platform 370 as the network of interconnected nodes consisting of servers, high-speed connections, and switches. Conceptually, the repetitive pattern of the nodes and connections suggests a woven or fabric-like nature. Computation components and storage components are part of the application fabric 372.

Over the operating system platform and its components, a cloud based services layer may include a cloud based services data access layer 352, a cloud based service core 354, and individual cloud based service applications 356 providing the above described services to online marketplace participants. A security and authentication component 362 may perform security tasks enabling a safe computing environment for the participants. The cloud based services 356 may provide standardized interfaces to and interact with ERP applications 358 and other client applications 360 of the participants.

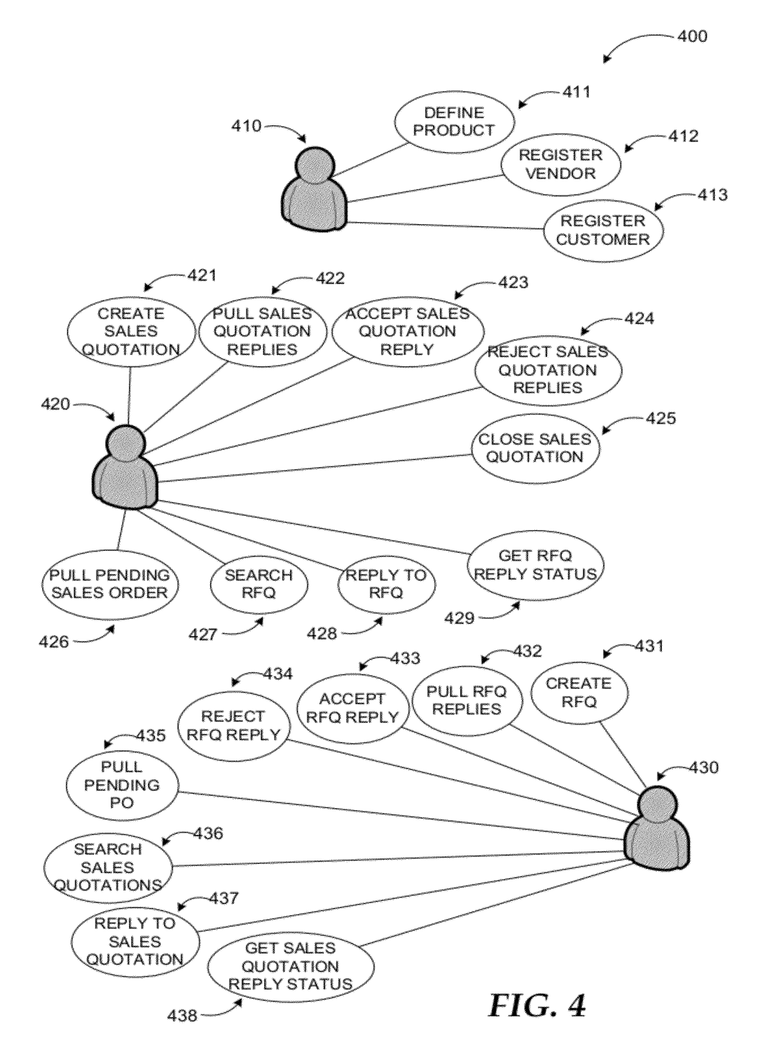

FIG. 4 illustrates potential actions that may be performed in a cloud based service environment by owners, suppliers, and consumers. The cloud based services may continuously check for published open proposals/requests to find matching pairs according to constraints specified by supplier/consumer. If there is no matching counterpart for a published request/proposal at the moment on the market then it may stay in the queue of unmatched ones until a suitable counterpart is posted. As soon as a matching pair is found both supplier and consumer may be informed and they can proceed with making a deal.

Thus, supply-demand matching is performed automatically by cloud-based service. The matching may be based on the constraints specified by supplier and consumer. The matching process may be executed continuously allowing real-time (event-based) processing. Moreover, consumers and suppliers may be enabled to post open requests and proposals to the online marketplace such that a specific partner is found and suggested automatically by cloud-based service.

As mentioned previously, a cloud based service platform according to embodiments provides services that are well aligned with supply chain workflows used standard business tools. The services may be able to either process requests inside the marketplace or redirect them to external third-party online marketplaces. The platform includes at least one integration module for the business tools, which allows the business tools to communicate with cloud marketplace services. Thus, the provided services are aligned with business tools workflows. The business tools are enabled to communicate with other business tools and the services through an integration module. And, an integration functionality is provided with other third-party online marketplaces without adding complexity on the client side.

A cloud based service platform according to embodiments combines software as a service (SaaS) and supply network as middleware platform enabling automation and integration of business processes. Thereby, the platform lowers the entry barriers for businesses to start up or enter a market and serves as a foundation for creating various specialized (geographically, vertically, or otherwise) online B2B supply networks and marketplaces. Examples of services also include authentication, communication, centralized data repository, order collaboration, warehouse space as a service, manufacturing capacity as a service, distribution as a service, payment processing, automatically expanding sourcing beyond the immediate list of “known” vendors, automatically expanding sales beyond the immediate list of “known” customers, automatic supply-demand matching, supply/demand monitoring and analytics, rating systems, dispute resolution and other supporting services.

Diagram 400 displays example actions that may be performed in a cloud based service environment by owners, suppliers, and consumers. For example, an owner 410 of the cloud based service may define products (411), register vendors (412), and register customers (413). A supplier 420 may create sales quotations (421), pull sales quotation replies (422), accept/reject sales quotation replies (423, 424), and close sales quotations (425). Supplier 420 may also pull pending sales orders (426), search for RFQs (427), reply to RFQs (428), and get RFQ reply status (429).

A consumer 430 may create RFQs (431), pull RFQ replies (432), accept/reject RFQ replies (433, 434), pull pending purchase orders (435), search for sales quotations (436), reply to sales quotations (437), and obtain sales quotation reply status (438).

A platform according to embodiments may impact B2B marketplace similar to social networking's impact on personal communication, where it removes the barriers between large and small entities and makes it equally possible for companies/businesses of different sizes to compete equally. As a result, the marketplace moves closer toward an efficient market with enhanced supply/demand matching, greater long-term efficiencies, and lower costs.

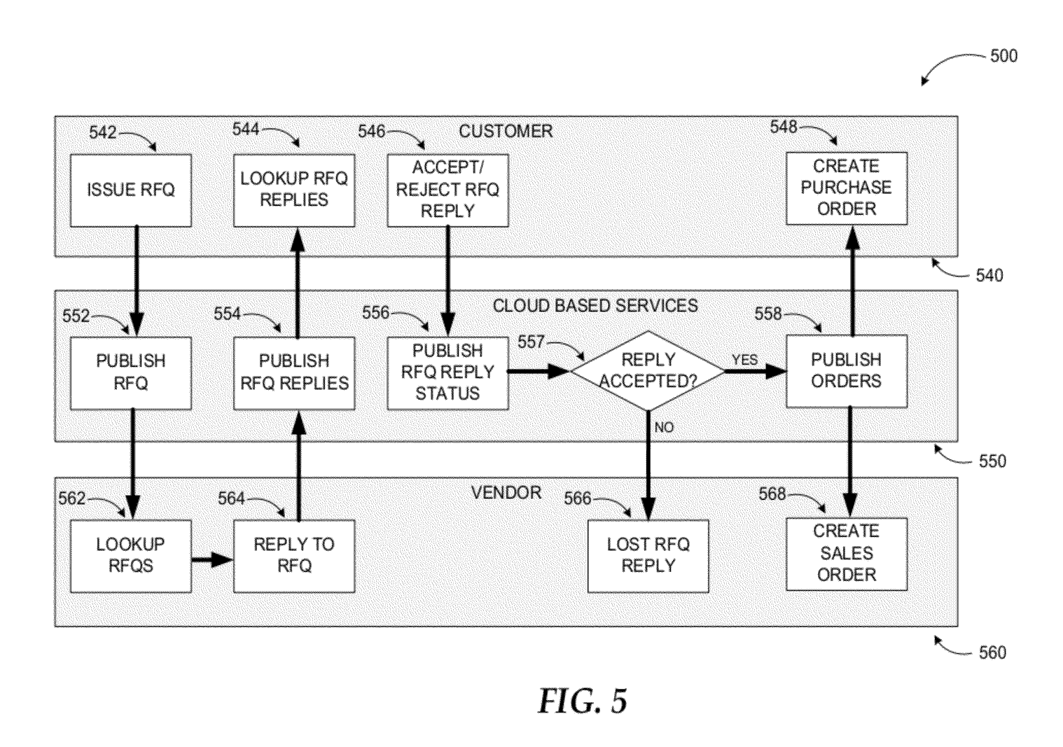

Following specific capabilities may be provided. A transport mechanism providing support for electronic document interchange in direct bidding scenarios, where requests for quote (RFQ) are delivered automatically from customers to vendors and sales quotations are automatically delivered from vendors to customers; a sourcing mechanism that automatically expands sourcing beyond the immediate list of known vendors or customers and customer purchase order—vendor sales order synchronization; extension of support for indirect bidding and order processing through automatic supply-demand matching and transport support for complete order processing cycle (e.g., electronic delivery of packing slip, etc.). FIGS. 5 through 7 illustrate different example architectures for the above discussed capabilities.

FIG. 5 illustrates an example architecture for sourcing within a cloud based service platform according to embodiments. Architecture 500 includes three layers. Customer layer 540 may start with issuing an RFQ (542), which is published (552) by the cloud based service layer 550 such that vendors (vendor layer 560) can look up the RFQ (562) and reply to the RFQ (564). The cloud based layer 550 again publishes the RFQ replies (554) such that customers can look up the replies (544).

The customers can accept or reject the RFQ replies (546), which is published by the cloud based service layer 550 as RFQ rely status (556). If the reply is rejected (557), the vendor can determine that the RFQ reply is lost (566). On the other hand, if the reply is accepted (557), the cloud based service layer 550 may publish the order(s) (558), which result in creation of a purchase order (548) at the customer layer 540 and a sales order (568) at the vendor layer 560.

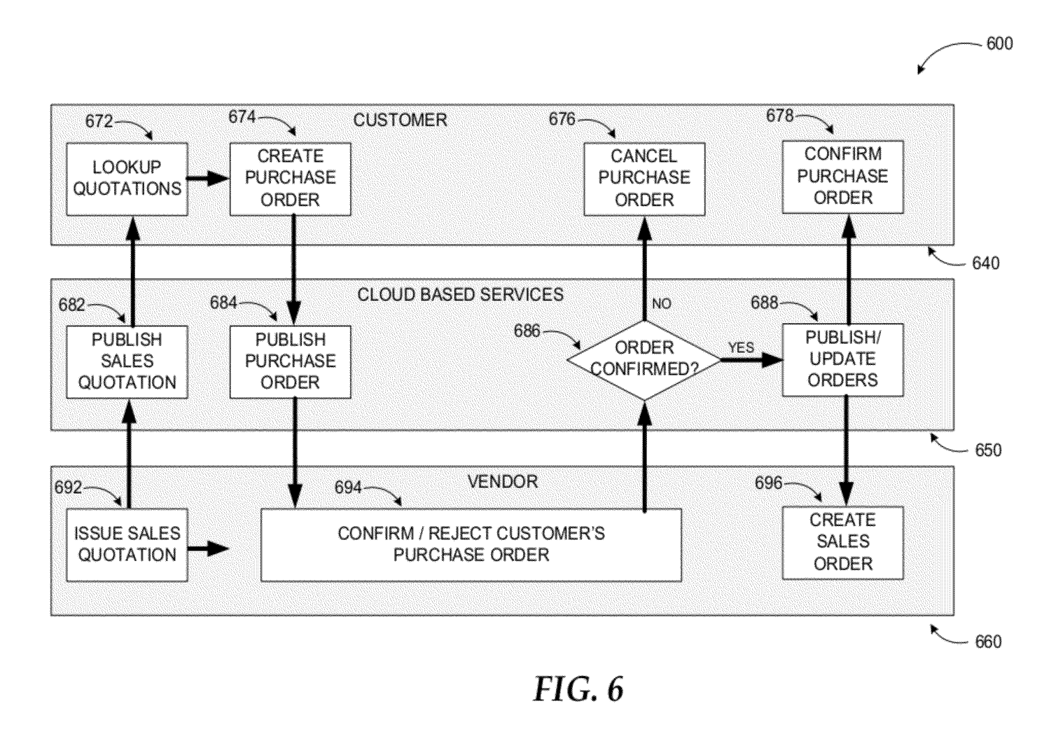

FIG. 6 illustrates another example architecture for selling within a cloud based service platform according to embodiments. Architecture 600 also includes three layers. Vendor layer 660 may start with issuing a sales quotation (692), which is published (682) by the cloud based service layer 650 such that a customer (customer layer 640) can look up the sales quotation (672) and create a purchase order (674). The cloud based layer 650 again publishes the purchase order (684) such that the vendor can confirm or reject the customer's purchase order (694).

If the order is not confirmed (686), the customer can cancel the purchase order (676). If the order is confirmed (686), the cloud based service layer 650 may publish/update the purchase order(s) (688) resulting in the vendor creating a sales order (696).

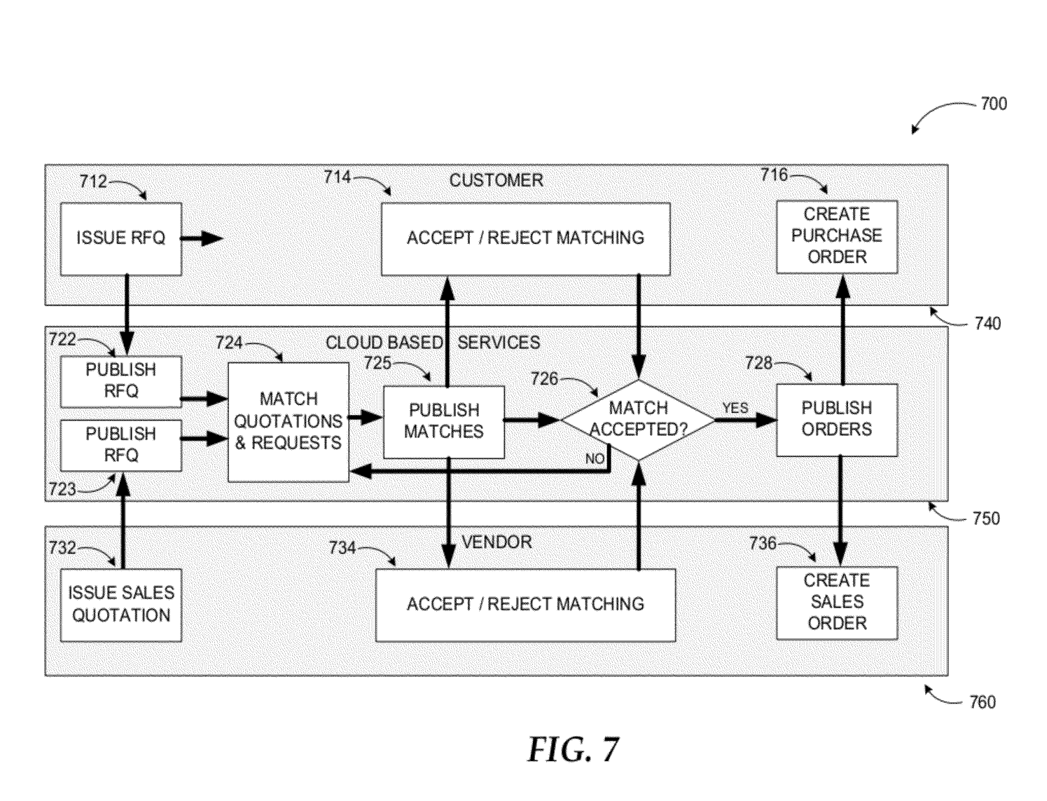

FIG. 7 illustrates a further example architecture for supply and demand matching within a cloud based service platform according to embodiments. Architecture 700 shows how cloud based service layer 750 provides automated supply and demand matching between customer layer 740 and vendor layer 760. The process may start with the customer issuing an RFQ (712) and the vendor issuing a sales order 732, which are both published (722, 723) by the cloud based service layer 750 and the quotations and requests are matched based on the constraints defined by the customer and vendor (724).

The matches are then published (725) to the customer and vendor, both of whom may accept or reject the matching (714, 734). If the match is rejected by either one of the customer or vendor, the process may return to matching. If the match is accepted by both parties, the purchase and sales orders may be created (716, 736) by the customer and the vendor, and published by the cloud based layer 750.

The example systems, components, interfaces, and interactions discussed in FIG. 1 through FIG. 7 are for illustration purposes only and do not constitute a limitation on embodiments. Integrated cloud based marketplace services may be implemented with other components, interactions, methods, and configurations using the principles described herein.

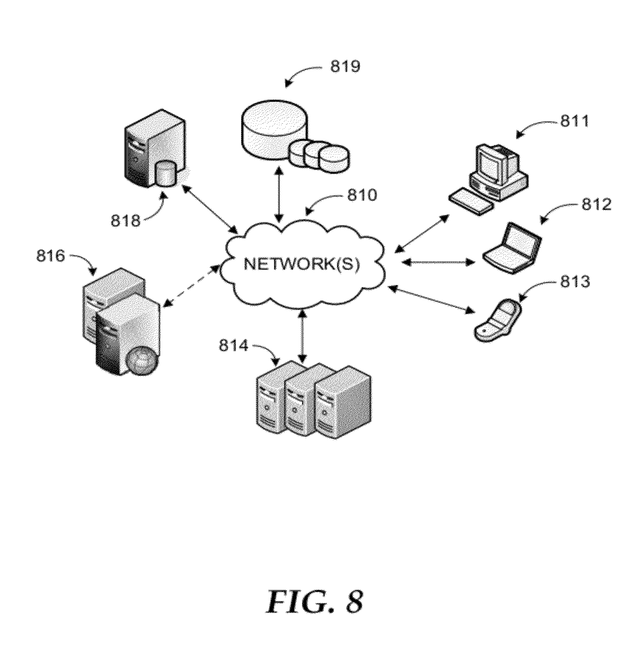

FIG. 8 is an example networked environment, where embodiments may be implemented. A platform providing cloud based B2B services may be implemented via software executed over one or more servers 814 and/or 816 such as a hosted service. The platform may communicate with client applications on individual computing devices such as a smart phone 813, a laptop computer 812, or desktop computer 811 (client devices') through network(s) 810.

As discussed above, the platform providing cloud based B2B services may enable seamless interaction of business tools between consumers and suppliers of goods and services, automatically match orders and requests, provide communication/processing/rating services, and so on. Individual users of the services (e.g., representative of participating businesses) may access the services through client devices 811-813. Data associated with the provided services may be stored directly or through database server 818 at data stores 819. Network(s) 810 may comprise any topology of servers, clients, Internet service providers, and communication media. A system according to embodiments may have a static or dynamic topology. Network(s) 810 may include secure networks such as an enterprise network, an unsecure network such as a wireless open network, or the Internet. Network(s) 810 may also coordinate communication over other networks such as Public Switched Telephone Network (PSTN) or cellular networks. Furthermore, network(s) 810 may include short range wireless networks such as Bluetooth or similar ones. Network(s) 810 provide communication between the nodes described herein. By way of example, and not limitation, network(s) 810 may include wireless media such as acoustic, RF, infrared and other wireless media.

Many other configurations of computing devices, applications, data sources, and data distribution systems may be employed to implement a cloud based B2B service platform. Furthermore, the networked environments discussed in FIG. 8 are for illustration purposes only. Embodiments are not limited to the example applications, modules, or processes.

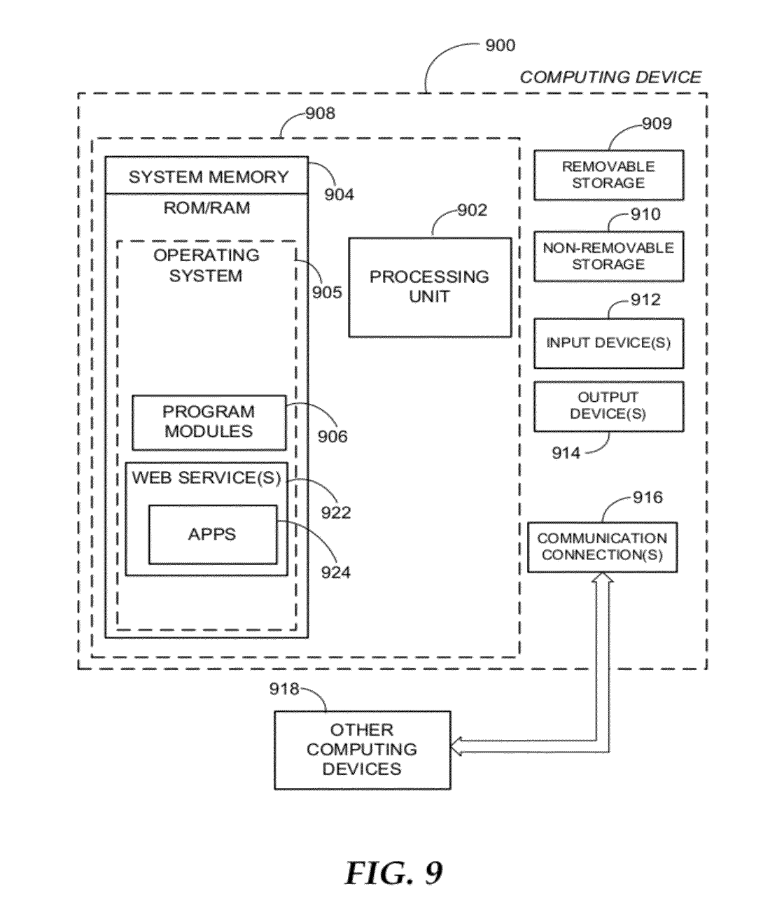

FIG. 9 and the associated discussion are intended to provide a brief, general description of a suitable computing environment in which embodiments may be implemented. With reference to FIG. 9, a block diagram of an example computing operating environment for an application according to embodiments is illustrated, such as computing device 900. In a basic configuration, computing device 900 may be a server executing one or more applications associated with a cloud based B2B service and include at least one processing unit 902 and system memory 904. Computing device 900 may also include a plurality of processing units that cooperate in executing programs. Depending on the exact configuration and type of computing device, the system memory 904 may be volatile (such as RAM), non-volatile (such as ROM, flash memory, etc.) or some combination of the two. System memory 904 typically includes an operating system 905 suitable for controlling the operation of the platform, such as the WINDOWS® operating systems from MICROSOFT CORPORATION of Redmond, Wash. The system memory 904 may also include one or more software applications such as program modules 906, web service(s) 922, and applications 924.

Web service(s) 922 may provide electronic data interchange between consumers and suppliers of service and goods in an electronic marketplace. Applications 924 may provide functionality associated with one or more business tools in finance, manufacturing, customer relationship management, supply chains, analytics, electronic commerce, and comparable aspects of business operations. With the integration of the business tools to the B2B service platform, suppliers and consumers may be enabled to interact efficiently, providing their offers, receiving matching replies, and following up through the same set of services as discussed previously. This basic configuration is illustrated in FIG. 9 by those components within dashed line 908.

Computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 909 and non-removable storage 910. Computer readable storage media may include volatile and nonvolatile, removable and non-removable media implemented in any method or technology for storage of information, such as computer readable instructions, data structures, program modules, or other data. System memory 904, removable storage 909 and non-removable storage 910 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer readable storage media may be part of computing device 900. Computing device 900 may also have input device(s) 912 such as keyboard, mouse, pen, voice input device, touch input device, and comparable input devices. Output device(s) 914 such as a display, speakers, printer, and other types of output devices may also be included. These devices are well known in the art and need not be discussed at length here.

Computing device 900 may also contain communication connections 916 that allow the device to communicate with other devices 918, such as over a wireless network in a distributed computing environment, a satellite link, a cellular link, and comparable mechanisms. Other devices 918 may include computer device(s) that execute web services, analysis services, data storage services, and comparable devices. Communication connection(s) 916 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

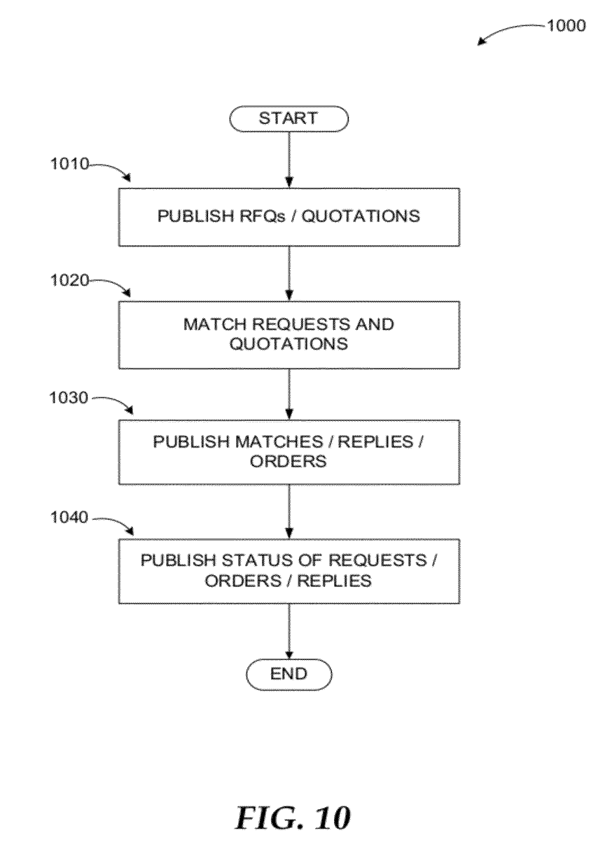

FIG. 10 illustrates a logic flow diagram for process 1000 of providing cloud based services in a B2B environment according to embodiments. Process 1000 may be implemented by a service executed on one or more servers communicating with other servers and client devices.

Process 1000 begins with operation 1010, where RFQs from customers and quotations from vendors are published such that each side can view available RFQs and quotations. At operation 1020, the requests may be automatically matched with quotations based on customer and vendor constraints enhancing an efficiency of the marketplace. The matches may be published at operation 1030. In response to the matches, vendor issued replies and customer issued orders may also be published such that either side can accept or reject them.

Upon acceptance of a match, corresponding purchase and sales orders may be created and published to conclude the exchange. The cloud based service may also publish status of requests, orders, and/or replies at operation 1040 such that customers and vendors can track the process real time. According to some embodiments, blanket orders may be enabled such that goods and services are provided to the consumer in regular increments. According to other embodiments, sales quotations from a plurality of suppliers may be synchronized with a purchase order (or request) such that the plurality of suppliers is transparent to the consumer. According to yet other embodiments, functionality for interaction between the cloud based services and the business tools may be encapsulated by a client-side managed class library.

The operations included in process 1000 are for illustration purposes. A cloud based service for B2B interactions according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing integrated cloud based marketplace services, the method comprising:
providing a cloud based service enabling data interchange between participants of a cloud based marketplace through integration of respective business tools, wherein the participants include consumers and suppliers of goods and services associated with the cloud based marketplace;
enabling a consumer to issue a request for quotation (RFQ);
publishing the RFQ such that a supplier is enabled to view and reply to the RFQ;
enabling the consumer to view and one of accept and reject the reply; and
if the reply is accepted, enabling creation of a purchase order and a sales order and publishing the purchase order and the sales order for automated completion of order processing.

2. The method of claim 1, further comprising:
publishing RFQ reply status to inform the consumer and the supplier.

3. The method of claim 1, further comprising:
automating a plurality of tasks such that workflows of the business tools are extended.

4. The method of claim 1, further comprising:
providing client integration artifacts to enable seamless integration of the cloud based services with functionality of the business tools.

5. The method of claim 1, wherein the cloud based services are rendered available on-demand.

6. The method of claim 1, further comprising:
creating at least one from a set of: a specialized supply network, a geographic supply network, and a vertical supply network through the cloud based services.

7. The method of claim 1, further comprising:
providing security and authentication services for participants of the cloud based marketplace.

8. A method executed at least in part in a computing device for providing integrated cloud based marketplace services, the method comprising:
providing a cloud based service enabling data interchange between participants of a cloud based marketplace through integration of respective business tools, wherein the participants include consumers and suppliers of goods and services associated with the cloud based marketplace;
enabling a supplier to issue a sales quotation;
publishing the sales quotation such that a consumer is enabled to view and create a purchase order;
publishing the purchase order to enable the supplier to one of confirm and reject the purchase order; and
if the purchase order is accepted, enabling confirmation of the purchase order and creation of a sales order by publishing an update to the purchase order.

9. The method of claim 8, further comprising:
if the purchase order is rejected by the supplier, enabling automatic cancellation of the purchase order at the consumer.

10. The method of claim 8, further comprising:
enabling a plurality of suppliers to issue sales quotations; and
synchronizing the sales quotations with the purchase order such that the plurality of suppliers is transparent to the consumer.

11. The method of claim 8, further comprising:
enabling blanket orders such that goods and services are supplied at regular increments.

12. The method of claim 8, wherein the cloud based services include at least one from a set: of master data services, trade communication services, marketplace services, analysis and rating services, and collaboration services.

13. The method of claim 12, wherein the master data services includes at least one from a set of: product catalogs, service catalogs, and supplier & consumer searches, and wherein the trade communication services include at least one from a set of: document exchange and order processing.

14. The method of claim 12, wherein the marketplace services include at least one from a set of: sales, sourcing, and quotation & request search, and wherein the analysis and rating services include at least one from a set of: supply and demand analysis, parties and products rating, and quotation suggestions.

15. The method of claim 12, wherein the collaboration services include at least one from a set of: similar product suggestions and peer-to-peer communications.

16. A computer-readable storage medium with instructions stored thereon for providing integrated cloud based marketplace services, the instructions comprising:
providing a web based operating platform;
providing a cloud based service layer enabling data interchange between participants of a cloud based marketplace through integration of respective business tools in an application layer;
enabling a consumer to issue a request for quotation (RFQ);
publishing the RFQ such that a supplier is enabled to view and reply to the RFQ;
enabling the consumer to view and one of accept and reject the reply;
if the reply is accepted, enabling creation of a purchase order and a sales order and publishing the purchase order and the sales order for automated completion of order processing;
enabling another supplier to issue a sales quotation;
publishing the sales quotation such that another consumer is enabled to view and create a purchase order;
publishing the purchase order to enable the other supplier to one of confirm and reject the purchase order; and
if the purchase order is accepted, enabling confirmation of the purchase order and creation of a sales order by publishing an update to the purchase order.

17. The computer-readable storage medium of claim 16, wherein the instructions further comprise:
providing standardized interfaces for integration with a plurality of third party marketplaces.

18. The computer-readable storage medium of claim 16, wherein the instructions further comprise:
enabling complete automated order processing cycle by providing payment processing and electronic delivery of packing slips.

19. The computer-readable storage medium of claim 16, wherein functionality for interaction between the cloud based services and the business tools is encapsulated by a client-side managed class library.

20. The computer-readable storage medium of claim 16, wherein the cloud based service layer is configured to define data contracts aligned with standardized electronic data interchange artifacts.
